(19) United States
(12) Patent Application Publication
(10) Pub. No.: US 2023/0394475 A1
(43) Pub. Date: Dec. 7, 2023

(54) PAYMENT ASSISTANCE APPARATUS, PAYMENT ASSISTANCE SYSTEM, PAYMENT ASSISTANCE METHOD, AND NON-TRANSITORY COMPUTER-READABLE MEDIUM

(71) Applicant: NEC Corporation, Minato-ku, Tokyo (JP)

(72) Inventors: Satoshi HIRATA, Tokyo (JP); Hajime Yamashita, Tokyo (JP); Kenta Aino, Tokyo (JP); Yuto Nishikawa, Tokyo (JP)

(73) Assignee: NEC Corporation, Minato-ku, Tokyo (JP)

(21) Appl. No.: 18/033,643

(22) PCT Filed: Nov. 5, 2020
(86) PCT No.: PCT/JP2020/041364

§ 371 Date: Apr. 25, 2023

(51) Int. Cl. G06Q 20/38; G06Q 30/0601

(52) U.S. Cl. CPC G06Q 20/3821; G06Q 30/0607; G06Q 20/387

(57) ABSTRACT

In the present disclosure, a payment assistance apparatus (1) includes: an authentication control unit (11) that controls biometric authentication, based on a captured image of a predetermined user being captured at a payment place; a decision unit (12) that decides display information, based on qualification information about service application associated with biometric information about the user who succeeds in the biometric authentication, when the biometric authentication succeeds; and a display control unit (13) that displays the decided display information in a position associated with the user in the captured image being displayed on a display device installed at the payment place.

### TECHNICAL FIELD

The present invention relates to a payment assistance apparatus, a payment assistance system, a payment assistance method, and a non-transitory computer-readable medium, and particularly relates to a payment assistance apparatus, a payment assistance system, a payment assistance method, and a non-transitory computer-readable medium, for assisting in payment.

### BACKGROUND ART

In recent years, a payment means using face authentication has been on the way to being widespread. Patent Literature 1 discloses a technique related to a biometric authentication payment system that performs payment processing by a predetermined payment system when biometric authentication such as face authentication succeeds. Furthermore, when face authentication succeeds, service application of a discount coupon can also be automatically performed on a predetermined payment target person.

### CITATION LIST

### Patent Literature

[Patent Literature 1] International Patent Publication No. WO2019/026196

### SUMMARY OF INVENTION

### Technical Problem

Herein, even a user who registers a face image (face feature information) for face authentication may not be set for collective processing from payment by face authentication to service application as in Patent Literature 1. Further, there is a user who desires another existing payment means (such as cash, a credit card, a debit card, and electronic money) instead of the collective processing from the payment to the service application even when the face authentication is used. Thus, a salesclerk who performs payment in a store needs to confirm whether a payment person is a target person of service application when payment by another payment means is performed, and the confirmation operation is complicated.

The present disclosure has been made in order to solve such a problem, and an object of the present disclosure is to provide a payment assistance apparatus, a payment assistance system, a payment assistance method, and a non-transitory computer-readable medium for reducing a load on a payment execution person (such as a salesperson) of confirming a qualification for service application of a payment target person and the like.

### Solution to Problem

A payment assistance apparatus according to a first aspect of the present disclosure includes:
an authentication control means for controlling biometric authentication, based on a captured image of a predetermined user being captured at a payment place;
a decision means for deciding display information, based on qualification information about service application associated with biometric information about the user, when the biometric authentication succeeds; and
a display control means for displaying the decided display information in a position associated with the user in the captured image being displayed on a display device installed at the payment place.

A payment assistance system according to a second aspect of the present disclosure includes:
a display device installed at a payment place;
an image-capturing device configured to capture a user at the payment place;
an authentication apparatus in which biometric information about a predetermined user is registered; and
a payment assistance apparatus,
wherein the payment assistance apparatus includes
   an authentication control means for controlling biometric authentication using the authentication apparatus, based on a captured image of the user being captured by the image-capturing device,
   a decision means for deciding display information, based on qualification information about service application associated with biometric information about the user, when the biometric authentication succeeds, and
   a display control means for displaying the decided display information in a position associated with the user in the captured image being displayed on the display device.

A payment assistance method according to a third aspect of the present disclosure includes,
by a computer:
controlling biometric authentication, based on a captured image of a predetermined user being captured at a payment place;
deciding display information, based on qualification information about service application associated with biometric information about the user, when the biometric authentication succeeds; and
displaying the decided display information in a position associated with the user in the captured image being displayed on a display device installed at the payment place.

A non-transitory computer-readable medium storing a payment assistance program according to a fourth aspect of the present disclosure causes a computer to execute:
authentication control processing of controlling biometric authentication, based on a captured image of a predetermined user being captured at a payment place;
decision processing of deciding display information, based on qualification information about service application associated with biometric information about the user, when the biometric authentication succeeds; and
display control processing of displaying the decided display information in a position associated with the user in the captured image being displayed on a display device installed at the payment place.

### Advantageous Effects of Invention

The present disclosure is able to provide a payment assistance apparatus, a payment assistance system, a payment assistance method, and a non-transitory computer-readable medium, for reducing a load on a payment execution person (such as a salesperson) of confirming a qualification for service application of a payment target person and the like.

### BRIEF DESCRIPTION OF DRAWINGS

FIG. 1 is a block diagram illustrating a configuration of a payment assistance apparatus according to a first example embodiment;

FIG. 2 is a flowchart illustrating a flow of a payment assistance method according to the first example embodiment;

FIG. 3 is a block diagram illustrating an overall configuration of a payment assistance system according to a second example embodiment;

FIG. 4 is a block diagram illustrating a configuration of an authentication apparatus according to the second example embodiment;

FIG. 5 is a flowchart illustrating a flow of face information registration processing according to the second example embodiment;

FIG. 6 is a flowchart illustrating a flow of face authentication processing by the authentication apparatus according to the second example embodiment;

FIG. 7 is a block diagram illustrating a configuration of a registration terminal according to the second example embodiment;

FIG. 8 is a block diagram illustrating a configuration of a payment assistance apparatus according to the second example embodiment;

FIG. 9 is a flowchart illustrating a flow of seat reservation processing according to the second example embodiment;

FIG. 10 is a flowchart illustrating a flow of face information registration processing at a time of an entry according to the second example embodiment;

FIG. 11 is a flowchart illustrating a flow of payment assistance processing according to the second example embodiment;

FIG. 12 is a diagram illustrating a concept of a display of display information according to the second example embodiment;

FIG. 13 is a diagram illustrating a display example of the display information according to the second example embodiment;

FIG. 14 is a diagram illustrating a display example of the display information according to the second example embodiment;

FIG. 15 is a diagram illustrating a display example of the display information according to the second example embodiment;

FIG. 16 is a flowchart illustrating a flow of payment assistance processing according to a third example embodiment;

FIG. 17 is a diagram illustrating a display example of display information according to the third example embodiment;

FIG. 18 is a diagram illustrating a display example of the display information according to the third example embodiment; and

FIG. 19 is a block diagram illustrating a configuration of a payment assistance apparatus according to a fourth example embodiment.

### EXAMPLE EMBODIMENT

Hereinafter, example embodiments of the present disclosure will be described in detail with reference to drawings. In each of the drawings, the same or corresponding elements will be denoted by the same reference signs, and duplicate description will be omitted depending on need for the sake of clarity of explanation.

### First Example Embodiment

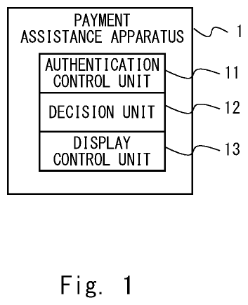

FIG. 1 is a block diagram illustrating a configuration of a payment assistance apparatus 1 according to a first example embodiment. The payment assistance apparatus 1 is an information processing apparatus for performing biometric authentication of a user who is a payment target person or an intended payment person, and displaying, on a display device installed at a payment place, display information according to qualification information about service application of the user who succeeds in the biometric authentication. Herein, the payment assistance apparatus 1 is connected to a network (not illustrated). The network may be wired or may be wireless. Further, an image-capturing device and the display device are connected to the network. The image-capturing device captures one or more payment target persons or intended payment persons (users) at a predetermined payment place. The image-capturing device transmits a captured image to the payment assistance apparatus 1 via the network. Note that the image-capturing device may be included in a payment terminal. Further, it is assumed that the display device is installed in a position that can be visually recognized by a payment execution person (such as a salesperson) at the payment place. The display device may be the payment terminal. Note that it is assumed that biometric information or identification information associated with the biometric information is registered in advance in association with qualification information in a predetermined storage device. Then, it is assumed that the storage device is connected to the network or built in the payment assistance apparatus 1.

The payment assistance apparatus 1 includes an authentication control unit 11, a decision unit 12, and a display control unit 13. The authentication control unit 11 controls biometric authentication, based on a captured image of a predetermined user being captured at a payment place. Herein, the predetermined user is a payment target person at the payment place, or an intended payment person who intends to perform payment after the payment target person. The authentication control unit 11 acquires a captured image being captured by the image-capturing device described above, and controls biometric authentication using biometric information about a user extracted from the captured image and biometric information in the storage device described above. Note that, when the payment assistance apparatus 1 includes the above-described storage device built therein, the authentication control unit 11 performs biometric authentication processing by performing a comparison between pieces of biometric information. Alternatively, when biometric information is stored in an external authentication apparatus, the authentication control unit 11 causes the authentication apparatus to perform biometric authentication processing and acquires an authentication result.

The decision unit 12 decides display information, based on qualification information about service application associated with the biometric information about the user when the biometric authentication succeeds. For example, the decision unit 12 determines qualification information associated with a user who succeeds in biometric authentication from the storage device described above, and decides display information, based on the determined qualification information.

Herein, the service application is, for example, a discount of a payment amount, purchase permission of a specific product group, and the like. Further, the qualification information is, for example, information indicating presence or absence of a membership qualification of a specific store group and a specific facility, a membership rank, whether the service application is enabled, presence or absence of a discount coupon, a degree of the service application, and the like. Further, the display information is, for example, information in which presence or absence of a qualification for the service application, a membership rank, a service content, a service level, and whether a purchase of a specific product group is permitted or not permitted can be visually recognized.

The display control unit 13 displays the decided display information in a position associated with the user in the captured image being displayed on the display device installed at the payment place. In other words, it is assumed that the display device displays the captured image on a screen. Then, the display control unit 13 transmits an instruction in such a way as to display the display information in the position of the user who succeeds in the biometric authentication in the captured image. For example, the display control unit 13 may transmit an instruction including the captured image, the position of the user, and the display information.

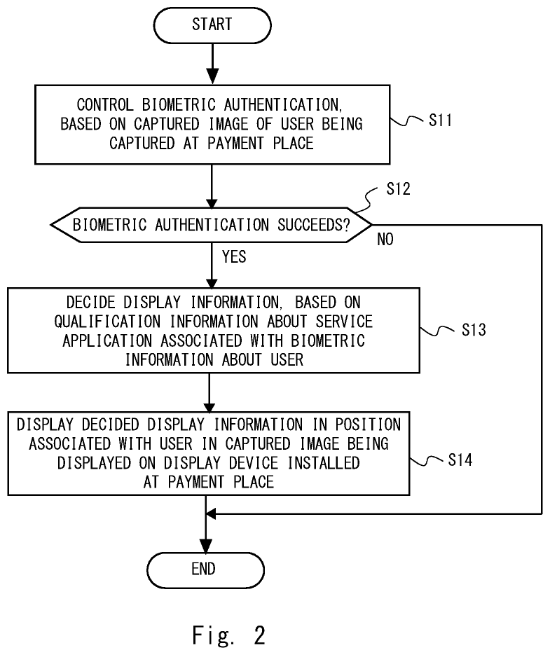

FIG. 2 is a flowchart illustrating a flow of a payment assistance method according to the first example embodiment. First, the image-capturing device installed near a payment place captures a user such as a payment target person, and transmits a captured image to the payment assistance apparatus 1 via the network. In response to this, the authentication control unit 11 acquires the captured image, and controls biometric authentication, based on the captured image (S11).

Next, the authentication control unit 11 determines whether the biometric authentication succeeds (S12). When the biometric authentication succeeds, the decision unit 12 decides display information, based on qualification information about service application associated with biometric information about the user who succeeds in the biometric authentication (S13). Then, the display control unit 13 displays the decided display information in a position associated with the user (who succeeds in the biometric authentication) in the captured image being displayed on the display device installed at the payment place (S14). Note that, when it is determined that the biometric authentication fails in step S12, the processing ends.

In this way, according to the present example embodiment, a salesperson and the like who perform payment at a payment place visually recognize display information being displayed on the display device, and can thus recognize presence or absence and a degree of a qualification for service application of a user who is a payment target person or an intended payment person. Thus, when the user is a person who meets the qualification for the service application, the salesperson and the like can perform the service application without making an inquiry from the user, and can then perform payment. Thus, a load on a payment execution person (such as a salesperson) of confirming a qualification for service application of a payment target person and the like can be reduced.

Note that the payment assistance apparatus 1 includes a processor, a memory, and a storage device as a configuration that is not illustrated. Further, the storage device stores a computer program in which processing of the payment assistance method according to the present example embodiment is implemented. Then, the processor reads the computer program from the storage device into the memory, and executes the computer program. In this way, the processor achieves a function of the authentication control unit 11, the decision unit 12, and the display control unit 13.

Alternatively, the authentication control unit 11, the decision unit 12, and the display control unit 13 may each be achieved by dedicated hardware. Further, a part or the whole of each of the components of each of the devices may be achieved by general-purpose or dedicated circuitry, processor, and the like, or achieved by a combination thereof. A part or the whole of each of the components may be formed by a single chip or formed by a plurality of chips connected to one another via a bus. A part or the whole of each of the components of each of the devices may be achieved by a combination of the above-described circuitry and the like and a program. Further, as the processor, a central processing unit (CPU), a graphics processing unit (GPU), a field-programmable gate array (FPGA), a quantum processor (quantum computer control chip), or the like can be used.

Further, when a part or the whole of each of the components of the payment assistance apparatus 1 is achieved by a plurality of information processing apparatuses, circuitry, or the like, the plurality of information processing apparatuses, the circuitry, or the like may be arranged in a centralized manner or a distributed manner. For example, the information processing apparatuses, the circuitry, and the like may be achieved as a form in which those are connected with each other via a client server system, a cloud computing system, or the like. Further, the function of the payment assistance apparatus 1 may be provided in a software as a service (SaaS) form.

### Second Example Embodiment

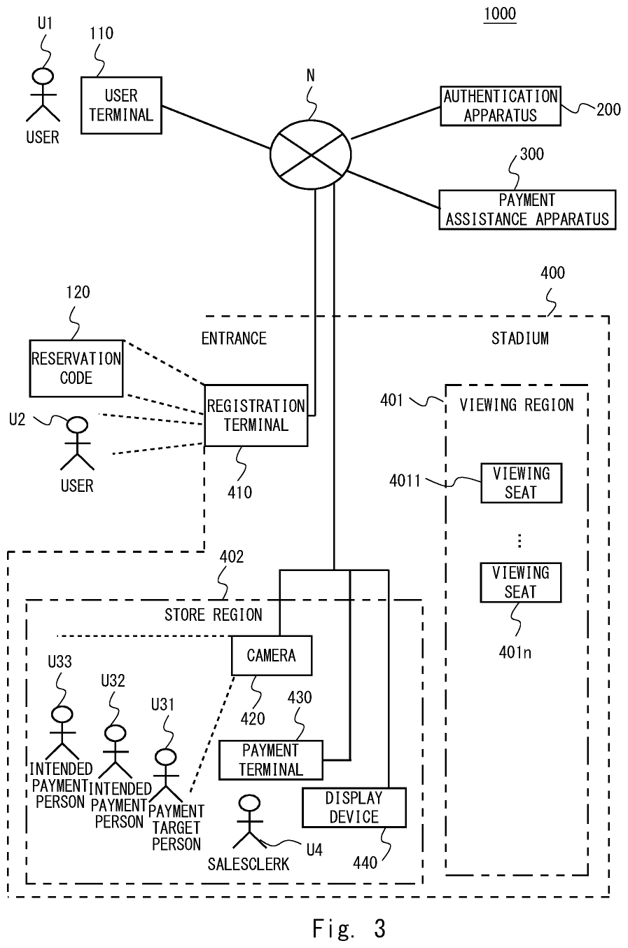

A second example embodiment is a specific example of the first example embodiment described above. FIG. 3 is a block diagram illustrating an overall configuration of a payment assistance system 1000 according to the second example embodiment. The payment assistance system 1000 displays, on a display device 440 for a salesclerk U4 in a store region 402 in a stadium 400, information indicating presence or absence of service application such as whether a payment target person U31 and intended payment persons U32 and U33 have a predetermined membership qualification. In this way, the salesclerk U4 can assist in the service application such as discount application at a time of payment without making an inquiry from the payment target person U31 about whether to have the membership qualification and the like.

Note that the membership qualification is a qualification to receive application of a service such as a discount in a product purchase in the store region 402. The membership qualification is, for example, a qualification of a paid member of a fan club such as a predetermined sport team. Then, a user having the membership qualification may be considered to have a right to purchase a ticket of a specific reserved seat of the stadium 400. Alternatively, the membership qualification may be acquired by any user purchasing a ticket of a specific reserved seat of the stadium 400.

Further, a reference of whether discount application is enabled may be changed in real time in response to a game content of a watching target. For example, in a case of possession of a membership qualification of a fan club of a team that is winning or losing during a game, the discount application may be received. Alternatively, in a case of possession of a membership qualification of a fan club of a winning team or a losing team after a game result is fixed, the discount application may be received. Further, a reference of whether the discount application is enabled may be changed in response to progress of a game. For example, the discount application may not be received during halftime and between innings of a game, and the discount application may be received during the game. In this way, customers who visit a store region can be dispersed, and congestion can be relieved.

Note that, in the following description, it is assumed that biometric authentication is face authentication and biometric information is face feature information, but another technique using a captured image can be applied to the biometric authentication and the biometric information. For example, the biometric information may use data (feature value) calculated from a physical feature being unique to an individual such as a fingerprint, a voiceprint, a vein, a retina, and a pattern of an iris of a pupil.

The stadium 400 is one example of a predetermined viewing facility. The stadium 400 includes a registration terminal 410 installed at an entrance, and includes a viewing region 401 and the store region 402. The registration terminal 410 is an information terminal that reads a reservation code 120 (reservation information about a specific reserved seat of a viewing seat) presented by a user U2 who is a spectator of the stadium 400, acquires a face image of the user U2, and requests face image (face information) registration from a payment assistance apparatus 300. In this way, the user U2 is determined to have a membership qualification in the stadium 400, and receives service application such as a discount. Note that a detailed configuration of the registration terminal 410 will be described below.

The viewing region 401 is a region for a spectator (user) who purchases a viewing ticket to view a predetermined event (such as a game of a sport, a concert, a theatrical performance, and a movie). The viewing region 401 includes a plurality of viewing seats 4011 to 401n (n is a natural number of two or more). It is assumed that the viewing seat 4011 and the like include a specific reserved seat. Thus, a spectator includes a user who purchases a reserved seat ticket.

The store region 402 is a region where a purchase sale such as goods is performed for a spectator (user) of the stadium 400. The store region 402 includes a camera 420, a payment terminal 430, and the display device 440. The payment terminal 430 is an information terminal for processing, by an operation of the salesclerk U4, payment of a purchase price of the payment target person U31 who is a person desiring to purchase a product. The payment terminal 430 may be a so-called cash register terminal. The payment terminal 430 can perform payment by a general payment means such as cash payment, credit card payment, debit card payment, electronic money payment, and code payment. Surroundings of the payment terminal 430 are one example of the payment place. It is assumed that the payment target person U31 is located in front of the payment terminal 430, and the intended payment persons U32 and U33 lining up behind the payment target person U31. The camera 420 is one example of an image-capturing device installed near the payment terminal 430. The camera 420 is installed in a position in which a region including the payment target person U31 in front of the payment terminal 430 and the intended payment persons U32 and U33 can be captured. The camera 420 transmits a captured image to the payment assistance apparatus 300 via a network N. The display device 440 is installed in a position in which at least the salesclerk U4 can visually recognize the screen. The display device 440 receives a captured image, display information described below, and a specification of a display position of the display information from the payment assistance apparatus 300 via the network N. The display device 440 displays the captured image, and also displays the display information in the display position specified in the captured image. Then, when the display information indicates that the payment target person U31 or the like is a user (member) who purchases a reserved seat ticket, the salesclerk U4 performs an operation on the payment terminal 430 in such a way as to apply a discount to a payment amount, and performs payment processing. Note that, a target person who receives service application such as a discount is not limited to a person who purchases a reserved seat ticket. In other words, there are various examples of the display information as described below, and the display information may be information indicating (visualizing) a target person or a non-target person of service application other than a discount. Further, the display information may be information that can identify a target person and a non-target person of service application. Note that the second example embodiment is not limited to the store region 402 in the stadium 400, and can also be applied to a payment place outside the stadium 400. Further, a viewing facility is not limited to the stadium 400.

The payment assistance system 1000 includes a user terminal 110, an authentication apparatus 200, the payment assistance apparatus 300, the registration terminal 410, the camera 420, the payment terminal 430, and the display device 440. The user terminal 110, the authentication apparatus 200, the payment assistance apparatus 300, the registration terminal 410, the camera 420, the payment terminal 430, and the display device 440 are connected to one another via the network N. Herein, the network N is a wired or wireless communication line.

The user terminal 110 is an information terminal operated by a user U1 desiring to view in the stadium 400. The user terminal 110 is, for example, a portable phone terminal, a smartphone, a tablet terminal, a personal computer (PC), and the like. The user U1 operates the user terminal 110, and makes a reservation for a seat of a reserved seat (online purchase of a reserved seat ticket) of the stadium 400 in advance. For example, the user terminal 110 accesses the payment assistance apparatus 300 via the network N in response to an operation of the user U1, makes a reservation for a seat, and receives a reservation code issued according to a reservation content. The user terminal 110 can display the received reservation code on a screen. Further, the user U1 can also print the displayed reservation code. The reservation code may be a one-dimensional bar code, a two-dimensional bar code, numerical information, and the like.

Note that it is assumed herein that the payment assistance apparatus 300 also functions as an online purchase site of a reserved seat of the stadium 400. However, the online purchase site may be a server other than the payment assistance apparatus 300. In that case, it is assumed that the server notifies the payment assistance apparatus 300 of reservation information being associated with an issued reservation code, and the payment assistance apparatus 300 stores the reservation information.

The user U2 is a spectator who visits the stadium 400 on the day of an event. It is assumed that the user U2 has already acquired the reservation code 120 in advance like the user U1 described above. Herein, it is assumed that the reservation code 120 is associated with the reservation information about the specific reserved seat described above. For example, the user U2 displays the reservation code 120 on a screen of a user terminal (not illustrated), and causes the registration terminal 410 to read the reservation code 120. Alternatively, the user U2 may present the printed reservation code 120, and cause the registration terminal 410 to read the reservation code 120. When the reservation code 120 has no problem, the user U2 captures an area including a face by the registration terminal 410. When face information about the user U2 is registered via the registration terminal 410, the user U2 can enter the stadium 400. Subsequently, the user U2 can view the event in a purchased viewing seat in the viewing region 401. Further, the user U2 can purchase a product in the store region 402. At this time, since the user U2 reserves the specific reserved seat, a service such as a discount from a purchase amount is applied.

The authentication apparatus 200 is an information processing apparatus that stores face feature information about a plurality of persons (spectators). Further, in response to a face authentication request being received from the outside, the authentication apparatus 200 performs a comparison between a face image or face feature information included in the request and face feature information about each user, and returns a comparison result (authentication result) to a request source.

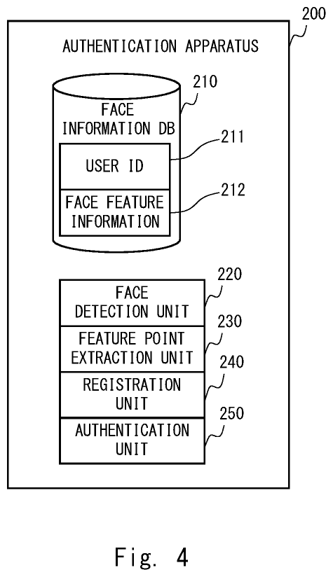

FIG. 4 is a block diagram illustrating a configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a group of feature points extracted from a face image. Note that the authentication apparatus 200 may delete the face feature information 212 in the face information DB 210 in response to a request from a registered user of the face feature information 212. Alternatively, the authentication apparatus 200 may delete the face feature information 212 from registration after a predetermined period has elapsed.

The face detection unit 220 detects a face area included in a registration image for registering face information, and outputs the face area to the feature point extraction unit 230. The feature point extraction unit 230 extracts a feature point from the face area detected by the face detection unit 220, and outputs face feature information to the registration unit 240. Further, the feature point extraction unit 230 extracts a feature point included in a face image received from the user terminal 110, the registration terminal 410, or the payment assistance apparatus 300, and outputs face feature information to the authentication unit 250.

The registration unit 240 newly issues the user ID 211 at a time of registration of the face feature information. The registration unit 240 registers, in the face information DB 210, the issued user ID 211 and the face feature information 212 extracted from the registration image in association with each other. The authentication unit 250 performs face authentication using the face feature information 212. Specifically, the authentication unit 250 performs a comparison between the face feature information extracted from the face image and the face feature information 212 in the face information DB 210. When the comparison succeeds, the authentication unit 250 determines the user ID 211 being associated with the compared face feature information 212. The authentication unit 250 returns presence or absence of coincidence of the face feature information as a face authentication result to the payment assistance apparatus 300. Presence or absence of coincidence of the face feature information is associated with whether authentication succeeds or fails. Note that the coincidence (presence of coincidence) of the face feature information refers to a case where a degree of coincidence is equal to or more than a predetermined value. Further, when face authentication succeeds, it is assumed that a face authentication result includes a determined user ID.

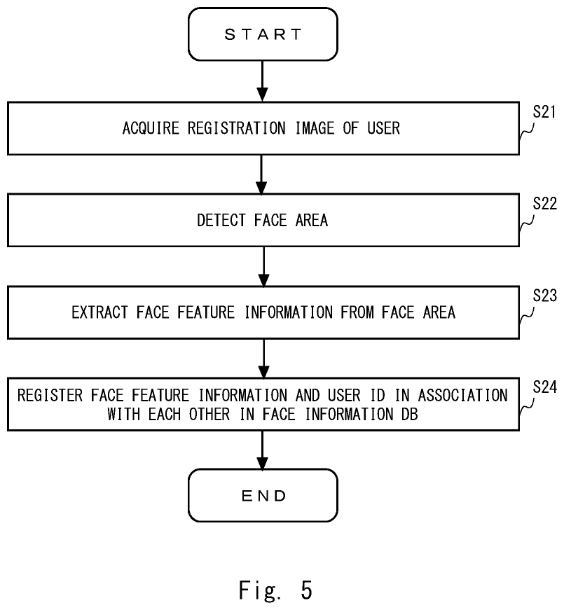

FIG. 5 is a flowchart illustrating a flow of face information registration processing according to the second example embodiment. Herein, an information registration terminal (not illustrated) captures a body including a face of a spectator (user), and transmits a face information registration request including the captured image (registration image) to the authentication apparatus 200 via the network N. The information registration terminal is, for example, an information processing apparatus such as a personal computer, a smartphone, a tablet terminal, or the like. For example, the information registration terminal may be the registration terminal 410 installed at the entrance of the stadium 400. Alternatively, the information registration terminal may be the payment assistance apparatus 300 that receives a face information registration request from the registration terminal 410.

First, the authentication apparatus 200 acquires a registration image included in a face information registration request (S21). For example, the authentication apparatus 200 receives the face information registration request from the information registration terminal via the network N. Next, the face detection unit 220 detects a face area included in the registration image (S22). Next, the feature point extraction unit 230 extracts a feature point from the face area detected in step S22, and outputs face feature information to the registration unit 240 (S23). Lastly, the registration unit 240 issues the user ID 211, and registers the user ID 211 and the face feature information 212 in association with each other in the face information DB 210 (S24). Note that the authentication apparatus 200 may receive the face feature information 212 from the information registration terminal, and register the face feature information 212 in association with the user ID 211 in the face information DB 210. Further, the registration unit 240 may notify the payment assistance apparatus 300 of a registered (issued) user ID.

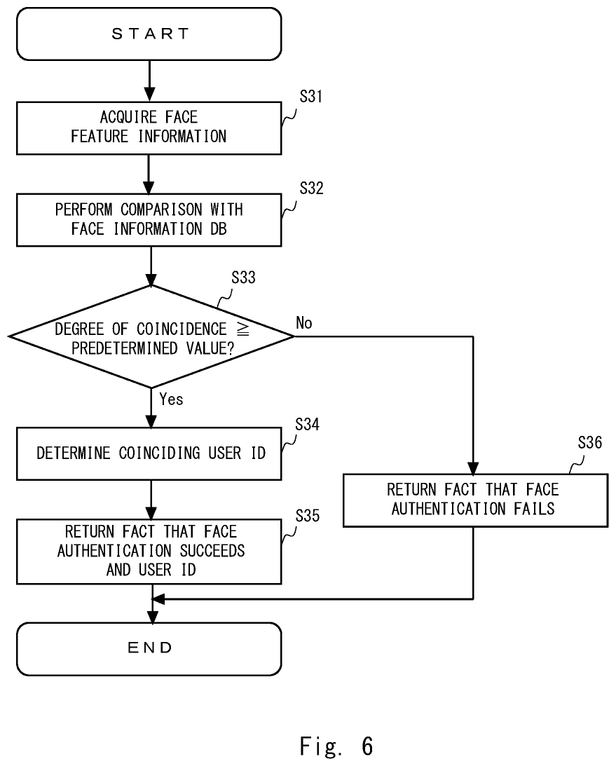

FIG. 6 is a flowchart illustrating a flow of face authentication processing by the authentication apparatus 200 according to the second example embodiment. First, the feature point extraction unit 230 acquires an authentication face image included in a face authentication request (S31). For example, the authentication apparatus 200 receives a face authentication request from the payment assistance apparatus 300 via the network N, and extracts face feature information from a face image included in the face authentication request as in steps S21 to S23. Alternatively, the authentication apparatus 200 may receive face feature information from the payment assistance apparatus 300. Next, the authentication unit 250 compares the acquired face feature information with the face feature information 212 in the face information DB 210 (S32). When the pieces of face feature information coincide with each other, that is, when a degree of coincidence of the face feature information is equal to or more than a predetermined value (Yes in S33), the authentication unit 250 determines the user ID 211 of a user whose face feature information coincides (S34), and returns a fact that face authentication succeeds and the determined user ID 211 to the payment assistance apparatus 300 (S35). When there is no coinciding face feature information (No in S33), the authentication unit 250 returns a fact that the face authentication fails to the payment assistance apparatus 300 (S36).

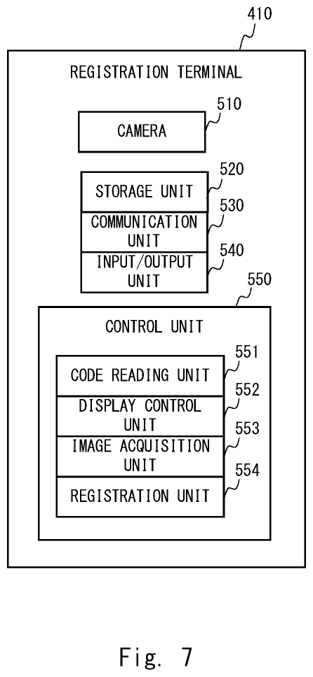

FIG. 7 is a block diagram illustrating a configuration of the registration terminal 410 according to the second example embodiment. The registration terminal 410 includes a camera 510, a storage unit 520, a communication unit 530, an input/output unit 540, and a control unit 550. The camera 510 is an image-capturing device that performs capturing in response to control of the control unit 550. Note that the camera 510 may not be built in the registration terminal 410, and may be connected to the registration terminal 410. The storage unit 520 is a storage device that stores a program for achieving each function of the registration terminal 410. The communication unit 530 is a communication interface with the network N. The input/output unit 540 includes a display device and an input device. The input/output unit 540 is, for example, a touch panel. The control unit 550 performs control of hardware included in the registration terminal 410. The control unit 550 includes a code reading unit 551, a display control unit 552, an image acquisition unit 553, and a registration unit 554.

The code reading unit 551 reads the reservation code 120 via a code reader (not illustrated) connected to the registration terminal 410, analyzes the reservation code 120, and acquires a reservation ID. Herein, the reservation ID is information that identifies reservation information about a viewing seat (specific reserved seat) of the stadium 400. Then, the code reading unit 551 transmits the acquired reservation ID to the payment assistance apparatus 300 via the network N.

The display control unit 552 receives the reservation information associated with the reservation ID from the payment assistance apparatus 300 via the network N, and displays the reservation information on the input/output unit 540. At this time, furthermore, the display control unit 552 may display a face capturing request message on the input/output unit 540.

The image acquisition unit 553 controls the camera 510, causes the camera 510 to capture at least a face area of the user U2, and acquires a captured image.

The registration unit 554 transmits a face information registration request including the captured image to the payment assistance apparatus 300 via the network N.

Returns to FIG. 3, and description continues. The payment assistance apparatus 300 has a function of a sales site that performs an online sale of a reserved seat of an event held in the stadium 400. Further, the payment assistance apparatus 300 receives a face image from the registration terminal 410, and registers face feature information based on the face image in the authentication apparatus 200. Further, the payment assistance apparatus 300 is an information processing apparatus that controls face authentication of a user, decides display information according to reservation information of the user who succeeds in the face authentication, and displays the decided display information on the display device 440. The payment assistance apparatus 300 may be made redundant by a plurality of servers, or each functional block may be achieved by a plurality of computers.

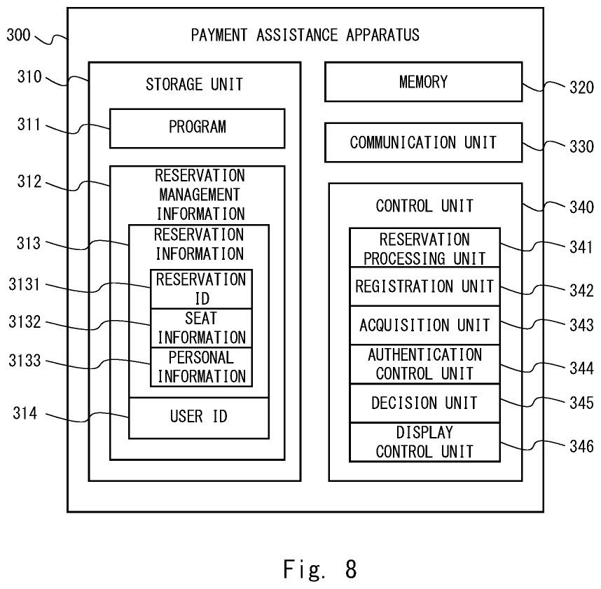

Next, the payment assistance apparatus 300 will be described in detail. FIG. 8 is a block diagram illustrating a configuration of the payment assistance apparatus 300 according to the second example embodiment. The payment assistance apparatus 300 includes a storage unit 310, a memory 320, a communication unit 330, and a control unit 340. The storage unit 310 is one example of a storage device such as a hard disk and a flash memory. The storage unit 310 stores a program 311 and a reservation management information 312. The program 311 is a computer program in which processing of the payment assistance method according to the second example embodiment is implemented.

The reservation management information 312 is information for managing reservation information about a reserved seat of an event held in the stadium 400. In the reservation management information 312, reservation information 313 and a user ID 314 are associated with each other. The reservation information 313 is information in which at least a reservation ID 3131, seat information 3132, and personal information 3133 are associated with one another. The reservation ID 3131 is identification information about the reservation information. The seat information 3132 is information indicating a position of a reserved seat being reserved, a rank of the seat, and the like. The personal information 3133 is personal information including a name, an address, a phone number, an e-mail address, belonging, and the like of a user who makes a reservation. The personal information 3133 may include a membership ID and a membership type (rank). The reservation information 313 is one example of the qualification information described above, and indicates possession of a membership qualification when the seat information 3132 indicates a specific reserved seat. The user ID 314 is identification information about a user who is a spectator, and is information associated with the user ID 211 registered in the face information DB 210 in the authentication apparatus 200.

The memory 320 is a volatile storage device such as a random access memory (RAM), and is a storage area for temporarily holding information during an operation of the control unit 340. The communication unit 330 is a communication interface with the network N.

The control unit 340 is a processor, i.e., a control device that controls each configuration of the payment assistance apparatus 300. The control unit 340 reads the program 311 from the storage device 310 into the memory 320, and executes the program 311. In this way, the control unit 340 achieves a function of a reservation processing unit 341, a registration unit 342, an acquisition unit 343, an authentication control unit 344, a decision unit 345, and a display control unit 346.

The reservation processing unit 341 receives, from a user, a reservation for a reserved seat of a specific event held in the stadium 400, registers reservation information, issues a reservation code associated with the reservation information, and returns the reservation code to the person (user) who made the reservation. Herein, since the reservation code is information associated with the reservation information, it can be said that the reservation code is one example of qualification information issued for the user.

When the registration unit 342 receives a reservation ID associated with a reservation code from the registration terminal 410, the registration unit 342 acquires a part (reservation information 313) of the seat information 3132 and the personal information 3133 that are associated with the reservation ID 3131. Then, the registration unit 342 returns the acquired reservation information to the registration terminal 410. Further, when the registration unit 342 receives a face image from the registration terminal 410, the registration unit 342 transmits a face information registration request including the face image to the authentication apparatus 200, and receives a user ID issued at a time of registration of face information from the authentication apparatus 200. Then, the registration unit 342 includes, in the reservation management information 312, the received user ID 314 and the received reservation information 313 in association with each other, and registers the reservation management information 312 in the storage unit 310.

Note that the registration unit 342 can be referred as follows. In other words, the registration unit 342 receives qualification information (reservation information) issued for a user, and biometric information (face image or face feature information) acquired from the user. At that time, when the registration unit 342 receives the qualification information issued for the user from a predetermined registration terminal, the registration unit 342 transmits a registration request for the biometric information to the registration terminal, and receives the biometric information acquired from the user in the registration terminal in response to the registration request. Then, the registration unit 342 registers the received qualification information and the received biometric information in association with each other.

The acquisition unit 343 acquires, from the camera 420 via the network N, a captured image in which the payment target person U31 or the like present near the payment terminal 430 is captured. Note that the acquisition unit 343 may acquire an event content held in a facility including a payment place. Specifically, the acquisition unit 343 may acquire, in real time, information about a game content of a sport held in the stadium 400 including the store region 402. For example, it is assumed that a staff member of the stadium 400, a sport journalist, and the like input a game content to a predetermined terminal (not illustrated). The game content may be information indicating a score during a game, a winning/losing team during a game, a score of a game result, a winning/losing team after a game result is fixed, or the like. Then, the acquisition unit 343 acquires the game content from the predetermined terminal via the network N. Note that the acquisition unit 343 may receive an image in which an event content (such as a scoreboard) is captured via the network N, analyze the image, and determine the event content.

The authentication control unit 344 is one example of the authentication control unit 11 described above. Note that the authentication control unit 344 may have the function of the acquisition unit 343. The authentication control unit 344 controls face authentication, based on the captured image acquired by the acquisition unit 343. In other words, the authentication control unit 344 causes the authentication apparatus 200 to perform face authentication on a face image. For example, the authentication control unit 344 transmits a face authentication request including an acquired face image to the authentication apparatus 200 via the network N, and receives a face authentication result from the authentication apparatus 200. Note that the authentication control unit 344 may detect a face area of a user from a face image, and include an image of the face area in a face authentication request. Alternatively, the authentication control unit 344 may extract face feature information from a face area, and include the face feature information in a face authentication request. The authentication control unit 344 acquires a face authentication result from the authentication apparatus 200 via the network N, and outputs the face authentication result to the decision unit 345. Further, when face areas of a plurality of users are detected from a captured image, the authentication control unit 344 transmits a face authentication request for each of the users.

The decision unit 345 is one example of the decision unit 12 described above. When the face authentication result indicates success, the decision unit 345 determines the reservation information 313 being associated with the user ID 314 included in the face authentication result. Then, the decision unit 345 decides display information, based on the determined reservation information 313. At this time, the decision unit 345 determines whether the reservation information 313 satisfies a predetermined condition. For example, when the seat information 3132 included in the reservation information 313 is included in a specific seat group, the decision unit 345 determines that the predetermined condition is satisfied. Alternatively, when the face authentication result indicates success, the decision unit 345 may determine whether the predetermined condition is satisfied in consideration of an event content acquired by the acquisition unit 343 in addition to qualification information. For example, when a user who succeeds in face authentication has membership information about a winning team or a losing team, the decision unit 345 may determine that the predetermined condition is satisfied, based on an intermediate result or a game result of a game content held in the stadium 400. At this time, the decision unit 345 may determine whether membership information about a specific team is possessed by whether the seat information 3132 included in the reservation information 313 is included in a specific seat group as described above. When the predetermined condition is satisfied, the decision unit 345 decides, as the display information, information indicating that a user who succeeds in face authentication is a target person of service application. Herein, examples of the display information include a frame line surrounding a face of a user who succeeds in face authentication in a captured image. Alternatively, the display information may be character information indicating membership. Further, the service application includes discount application of a payment amount. Thus, the display information may be information indicating possession of a discount coupon. Note that the decision unit 345 determines a position of a face area of a user who succeeds in face authentication in a captured image.

The display control unit 346 is one example of the display control unit 13 described above. The display control unit 346 displays the captured image on the display device 440, and displays the display information decided by the decision unit 345 in a position associated with the user who succeeds in the face authentication in the captured image. Specifically, the display control unit 346 transmits the captured image, the display information, and a position in which the display information is displayed to the display device 440 via the network N. For example, the display control unit 346 displays the display information in such a way as to surround a face of the user in the captured image.

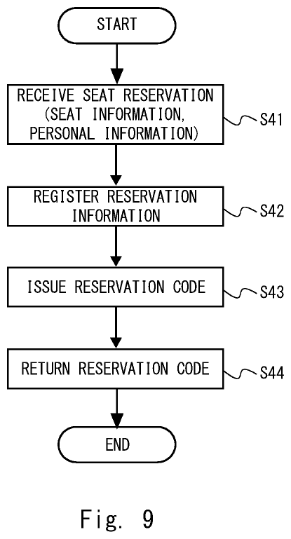

FIG. 9 is a flowchart illustrating a flow of seat reservation processing according to the second example embodiment. Herein, it is assumed that the user U1 reserves a reserved seat ticket of a viewing seat of a specific event held in the stadium 400. The user U1 may have a membership qualification to be able to reserve a specific reserved seat of the stadium 400.

First, the user terminal 110 accesses the payment assistance apparatus 300 via the network N in response to an operation of the user U1. For example, the user terminal 110 logs into an online sales site of a reserved seat ticket of the payment assistance apparatus 300 in response to an input of a membership ID and a password of the user U1. Then, the user terminal 110 transmits, to the payment assistance apparatus 300 via the network N, a seat reservation request including a specific viewing seat (reserved seat) being specified by the user U1. Note that the user terminal 110 may include personal information input from the user U1 in the seat reservation request. In response to this, the reservation processing unit 341 of the payment assistance apparatus 300 receives the seat reservation request from the user terminal 110 (S41).

Then, the reservation processing unit 341 issues a reservation ID when a seat specified by the seat reservation request is available. Note that, when the user U1 has the membership qualification described above, the reservation processing unit 341 may acquire personal information associated with a login ID of the user U1 from a membership DB (not illustrated). Then, the reservation processing unit 341 generates the reservation information 313 in which the issued reservation ID 3131, the specified seat information 3132, and the personal information 3133 about the user U1 (included in the seat registration request) are associated with one another. The reservation processing unit 341 registers the registration management information 312 including the reservation information 313 in the storage unit 310 (S42). Further, the reservation processing unit 341 issues a reservation code, based on the reservation ID 3131 (S43). Herein, the reservation code is information including at least a reservation ID. Furthermore, the reservation code may include personal information. Subsequently, the reservation processing unit 341 returns the reservation code to the user terminal 110 via the network N (S44).

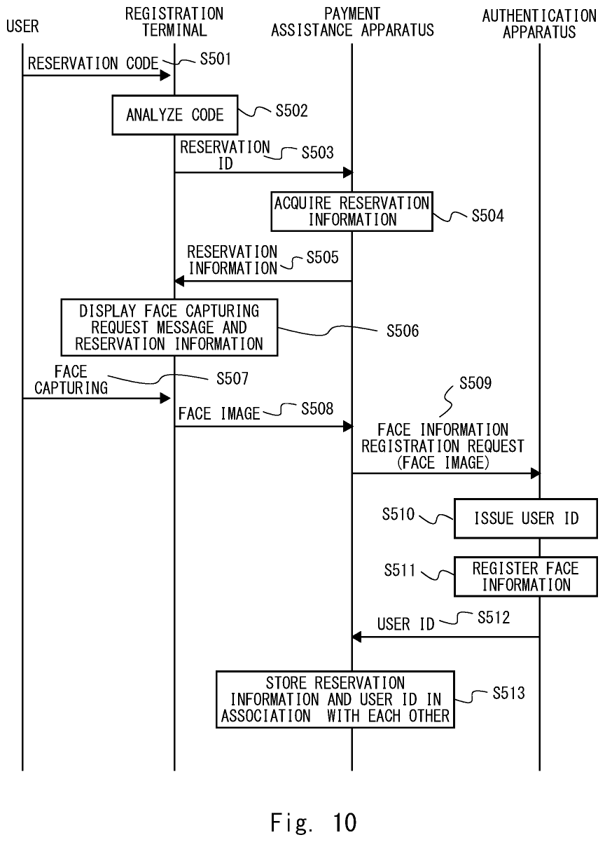

FIG. 10 is a flowchart illustrating a flow of face information registration processing at a time of an entry according to the second example embodiment. It is assumed herein that the user U2 has already acquired the reservation code 120 described above in advance, and arrives the entrance of the stadium 400 on the day of a specific event. First, the user U2 displays the reservation code 120 on his/her user terminal (not illustrated), and presents the reservation code 120 on the registration terminal 410 (S501). Note that the user U2 may present paper on which the reservation code 120 is printed.

In response to this, the code reading unit 551 of the registration terminal 410 acquires the reservation code 120 being read by the code reader, and analyzes the reservation code 120 (S502). The code reading unit 551 acquires a reservation ID by the analysis, and transmits the reservation ID to the payment assistance apparatus 300 via the network N (S503).

The registration unit 342 of the payment assistance apparatus 300 receives the reservation ID from the registration terminal 410 via the network N, and acquires a part (reservation information 313) of the seat information 3132 and the personal information 3133 that are associated with the received reservation ID 3131 from the reservation management information 312 (S504). Then, the registration unit 342 transmits the acquired reservation information 313 to the registration terminal 410 via the network N (S505). At this time, the registration unit 342 may also transmit a face capturing request message to the registration terminal 410.

The display control unit 552 of the registration terminal 410 receives the reservation information from the payment assistance apparatus 300 via the network N, and displays the face capturing request message and the reservation information on the input/output unit 540 (S506). In response to this, the user U2 confirms the part of the seat information and the personal information reserved by himself/herself via the screen of the registration terminal 410, and performs a capturing operation of a face on the registration terminal 410 when there is no problem (S507). In this way, the image acquisition unit 553 of the registration terminal 410 captures a face area of the user U2 by the camera 510, and acquires a captured image. Then, the registration unit 554 of the registration terminal 410 transmits the captured image to the payment assistance apparatus 300 via a network N (S508).

The registration unit 342 of the payment assistance apparatus 300 receives the face image from the registration terminal 410 via the network N, and transmits a face information registration request including the face image to the payment assistance apparatus 200 via the network N (S509). The authentication apparatus 200 receives the face information registration request from the payment assistance apparatus 300 via the network N, and extracts face feature information as described above. Then, the registration unit 240 of the authentication apparatus 200 newly issues a user ID (S510), and registers face information in association with the issued user ID 211 and the face feature information 212 in the face information DB 210 (S511). Subsequently, the registration unit 240 transmits the issued user ID to the payment assistance apparatus 300 via the network N (S512).

The registration unit 342 of the payment assistance apparatus 300 receives the user ID from the authentication apparatus 200 via the network N, includes, in the reservation management information 312, the received user ID 314 and the reservation information 313 acquired in step S504 in association with each other, and stores the reservation management information 312 in the storage unit 310 (S513). In this way, identification information (user ID 314) associated with the face feature information about the user U2 and qualification information (reservation information 313) about the user U2 are associated with each other.

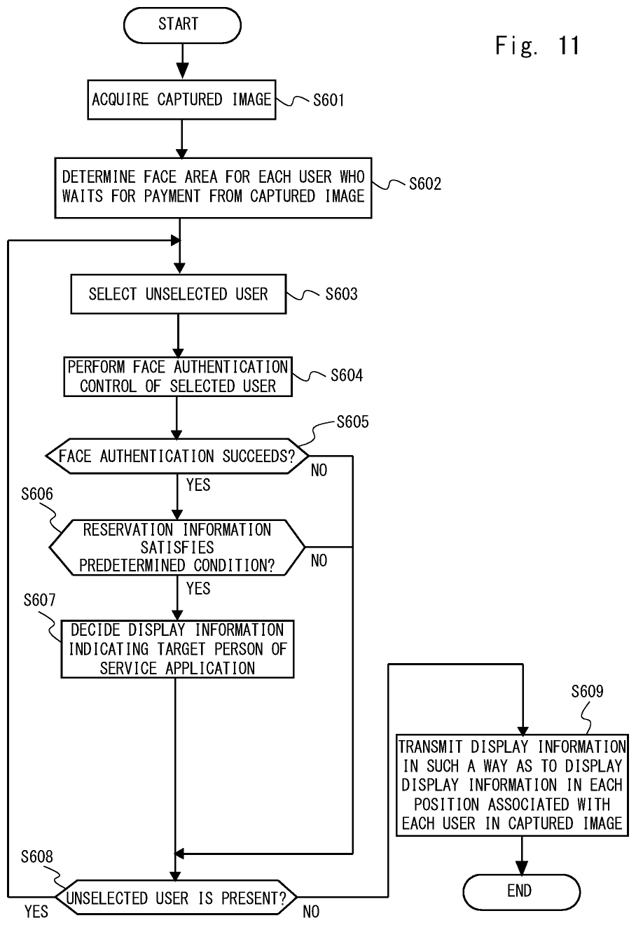

FIG. 11 is a flowchart illustrating a flow of payment assistance processing according to the second example embodiment. As a premise, like the user U2, each spectator who reserves a specific reserved seat and registers face information via the registration terminal 410 can view a specific event in his/her viewing seat 4011 or the like in the viewing region 401. Then, the spectator can drop by the store region 402 before, after, or during an event, and can receive service application such as a discount when a product or the like is purchased. It is assumed herein that the payment target person U31 and the intended payment persons U32 and U33 who are waiting for payment line up near the payment terminal 430 in the store region 402. Then, the camera 420 captures a region (payment place) including the payment target person U31 and the intended payment persons U32 and U33, and transmits a captured image to the payment assistance apparatus 300 via the network N. In response to this, the acquisition unit 343 of the payment assistance apparatus 300 acquires the captured image from the camera 420 via the network N (S601).

Then, the authentication control unit 344 determines a face area for each user who waits for payment from the captured image (S602). For example, the authentication control unit 344 analyzes the captured image, and determines a face area of three users of the payment target person U31 and the intended payment persons U32 and U33 in the captured image. In other words, a user being a target of biometric authentication includes the intended payment persons U32 and U33 lining up to perform payment behind the payment target person U31 in addition to the current payment target person U31 at the payment place.

Then, the authentication control unit 344 selects an unselected user from among the plurality of determined users (S603). For example, it is assumed that the authentication control unit 344 selects the payment target person U31. Thus, the authentication control unit 344 performs face authentication control of the selected user (S604). Specifically, the authentication control unit 344 transmits a face authentication request including the face area (face image) of the payment target person U31 to the authentication apparatus 200 via the network N, and receives a face authentication result from the authentication apparatus 200. Then, the authentication control unit 344 outputs the face authentication result to the decision unit 345.

In response to this, the decision unit 345 determines whether face authentication succeeds (S605). When it is determined that the face authentication succeeds, the decision unit 345 determines the reservation information 313 being associated with the user ID 314 included in the face authentication result. Then, the decision unit 345 determines whether the determined reservation information 313 satisfies a predetermined condition (S606). For example, when the seat information 3132 included in the reservation information 313 is included in a specific seat group, the decision unit 345 determines that the predetermined condition is satisfied. In this case, the decision unit 345 determines that the payment target person U31 has a membership qualification and is an application target person of a discount service. Thus, the decision unit 345 decides display information indicating the target person of the service application (S607). For example, the decision unit 345 may decide, as the display information, a red frame line surrounding the face area of the payment target person U31.

When NO is determined in step S607, or step S605 or S606, the authentication control unit 344 determines whether an unselected user is present among the plurality of determined users (S608). Herein, the unselected intended payment persons U32 and U33 are present in addition to the selected payment target person U31 among the plurality of determined users. Thus, it is assumed that the authentication control unit 344 selects the intended payment person U32 lining up behind the payment target person U31 (S603). Hereinafter, steps S604 to S607 are similarly performed. Further, for the intended payment person U33, steps S604 to S607 are also similarly performed.

Subsequently, when it is determined that an unselected user is not present in step S608, the display control unit 346 transmits the display information to the display device 440 in such a way as to display the decided display information in each position associated with each user in the captured image (S609). For example, the display control unit 346 transmits the captured image acquired in step S601, a position of the face area of each of the payment target person U31 and the intended payment persons U32 and U33 in the captured image, and the display information decided for each user. Alternatively, the display control unit 346 may generate an image in which the display information is embedded in the position associated with each user in the captured image, and transmit the image to the display device 440 via the network N. In this way, the display device 440 receives the captured image, the display information, and the display position from the payment assistance apparatus 300 via the network N, and accordingly displays the captured image and the display information on the screen.

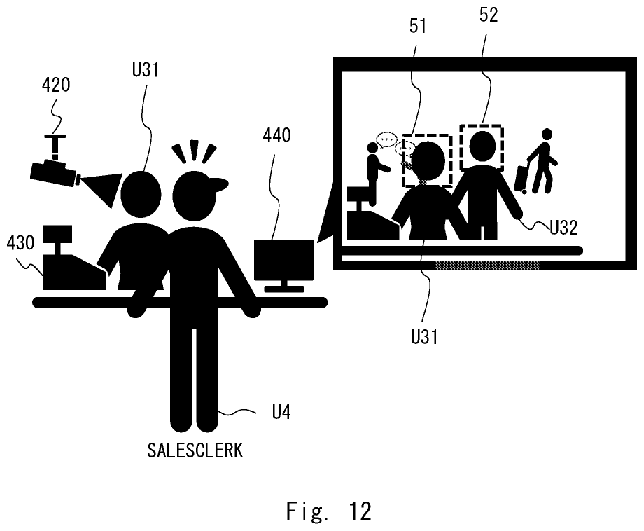

FIG. 12 is a diagram illustrating a concept of a display of display information according to the second example embodiment. Herein, it is illustrated that a captured image is displayed in the screen of the display device 440, display information 51 is displayed in a face area of the payment target person U31 in the captured image, and display information 52 is displayed in a face area of the intended payment person U32. The salesclerk U4 can recognize that the payment target person U31 has a membership qualification and is an application target person of a discount service by visually recognizing the display information 51 being displayed on the display device 440 when payment processing of the payment target person U31 is performed. Thus, the salesclerk U4 does not need to make an inquiry about possession of a membership qualification and request presentation of a membership card from the payment target person U31, and can subtract a predetermined discount amount from a payment amount and perform the payment processing by using the payment terminal 430. Further, the salesclerk U4 can recognize, in advance, that the intended payment person U32 who is a next payment target person also has a membership qualification and is an application target person of a discount service by visually recognizing the display information 52. Thus, the salesclerk U4 can smoothly perform application of the discount service when the salesclerk U4 performs the payment processing of the intended payment person U32.

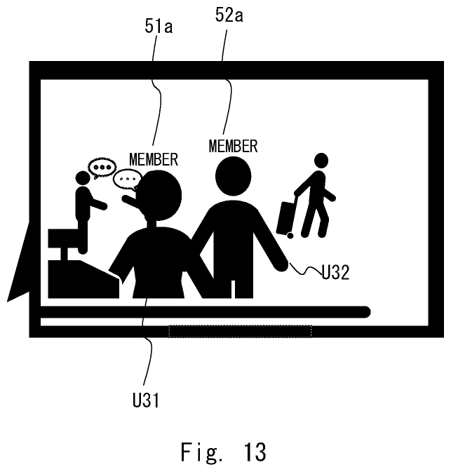

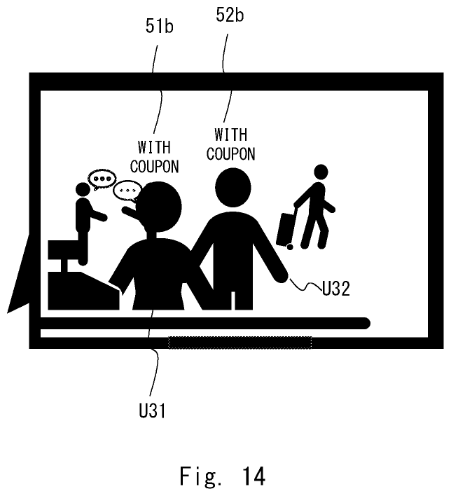

FIGS. 13 to 15 are diagrams illustrating a display example of the display information according to the second example embodiment. Herein, it is illustrated that characters of “member” are displayed near faces of the payment target person U31 and the intended payment person U32 in a captured image being displayed on the screen of the display device 440. FIG. 14 illustrates that characters of “with coupon” are displayed near the faces of the payment target person U31 and the intended payment person U32 in a captured image being displayed on the screen of the display device 440. From these, the salesclerk U4 can also easily recognize that the payment target person U31 is an application target person of a discount service, and can smoothly perform application of the discount service. Similarly, the salesclerk U4 can recognize, in advance, that the intended payment person U32 before payment is an application target person of a discount service, and can smoothly perform application of the discount service.

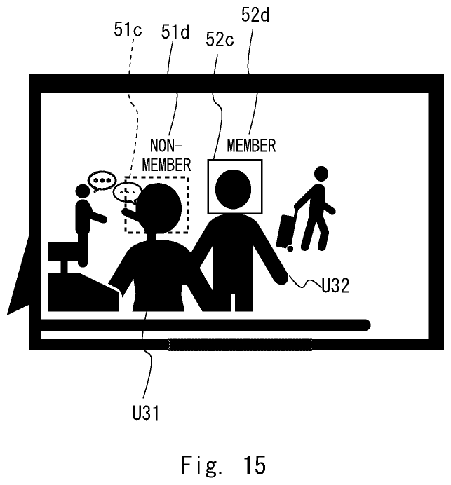

Note that the display device 440 may display both of a target person and a non-target person of service application in an identifiable manner. In that case, when NO is determined in step S606 in FIG. 11, the decision unit 345 decides second display information indicating the non-target person of the service application. Subsequently, the processing may proceed to step S608 similarly to the description above. For example, it is assumed that the payment target person U31 is a non-member, and the intended payment person U32 is a member. A display example in this case is illustrated in FIG. 15. Herein, it is illustrated that the display device 440 displays a frame line (display information 51c) by a broken line around a face area, and characters (display information 51d) of “non-member” near the face of the payment target person U31 in a captured image on the screen. Further, it is illustrated that the display device 440 displays a frame line (display information 52c) by a solid line around a face area, and characters (display information 52d) of “member” near the face of the intended payment person U32 in the captured image on the screen. Note that, in FIG. 15, any one of the pieces of display information 51c and 51d may be displayed. Similarly, any one of the pieces of display information 52c and 52d may be displayed. Furthermore, the pieces of display information 51c and 52c being the frame lines may have different colors. Further, the pieces of display information 51c and 52c being the frame lines may be common to either the solid line or the broken line and may distinguish a member and a non-member by color. From these, the salesclerk U4 can easily recognize that the payment target person U31 at the present point in time is a non-application person of a discount service and the intended payment person U32 who performs payment next is an application target person of the discount service, and can smoothly perform application of the discount service.

In this way, according to the present example embodiment, a seller can easily recognize, by using face authentication, presence or absence of service application and an application content of a payment target person and an intended payment person even with a payment means other than face authentication payment, and can smoothly perform application of a discount service. Furthermore, the camera 420 and the display device 440 are installed in the store region 402 (payment place) and connected to the network N, and thus the present example embodiment can be introduced without performing a repair on the existing payment terminal 430. Thus, an introduction cost can be reduced.

Furthermore, the present example embodiment may be modified as follows. For example, the decision unit 345 may further decide display information, based on a frequency with which a user visits a predetermined facility. In this case, it is assumed that the payment assistance apparatus 300 separately includes a viewing history of the stadium 400 for each user. Then, the decision unit 345 acquires a viewing history associated with a user who succeeds in face authentication, and determines that the user is a service application target when the number of times of the viewing histories is equal to or more than a predetermined value. Further, the decision unit 345 may collectively determine determined reservation information and a viewing history, and determine whether a user is a service application target. Alternatively, the decision unit 345 may collectively determine determined reservation information and a viewing history, decide a degree of service application, and decide display information according to the decided degree of service application. For example, the decision unit 345 may change a color of a frame line in order of blue, yellow, and red with a higher degree of service application. Furthermore, the decision unit 345 may decide, as display information, the number of times of viewing histories, the number of times of purchase histories, a total amount, and the like. In this case, the number of times of viewing (the number of times of viewing of games), the number of times of purchases, and the like may be displayed near a face area of an associated user on the screen of the display device 440. Furthermore, the decision unit 345 may change a color of a frame line from red to green when the number of times of viewing histories, the number of times of purchase histories, and the like exceed a predetermined number of times. In other words, when the number of times exceeds a predetermined value, a discount target may be set.

Further, the decision unit 345 may further decide display information, based on preference information about a user. In this case, it is assumed that the payment assistance apparatus 300 separately includes a database of preference information indicating an interest for each user. Then, the decision unit 345 may decide a service content according to determined reservation information and the preference information associated with a user who succeeds in face authentication, and decide display information according to the decided service content. For example, the decision unit 345 may distinguish a color of a frame line among blue, yellow, red, and the like according to the decided service content.

Further, the decision unit 345 may decide display information, based on belonging of a user. For example, when belonging included in the personal information 3133 indicates a specific company, the decision unit 345 may decide display information indicating a high discount rate.

Further, qualification information may include a service type that may be applied to a user. In that case, the decision unit 345 may decide display information being associated with the service type included in the qualification information.

### Third Example Embodiment

A third example embodiment is a modification example of the second example embodiment described above. It is assumed that qualification information according to the third example embodiment includes age information about a user. For example, it is assumed that the personal information 3133 described above includes a date of birth. In this case, when the age information included in the qualification information indicates a person under age (a minor), a decision unit 345 decides, as display information, information indicating that a purchase of a specific product group is not permitted. For example, the decision unit 345 determines whether a user is a person under age, based on a date of birth included in the determined personal information 3133. When the user is a person under age, the decision unit 345 may decide, as display information, description of “underage!” indicating that a purchase of alcoholic beverages is not permitted.

Note that an overall configuration of the third example embodiment and a configuration of a payment assistance apparatus 300 are similar to those in FIGS. 3 and 8, and thus illustration will be omitted and differences will be described below.

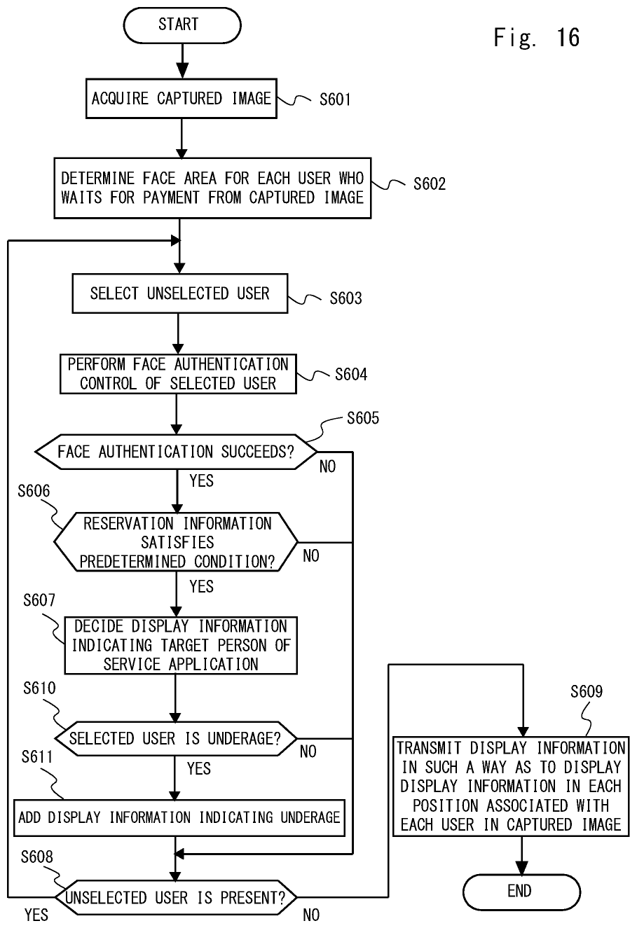

FIG. 16 is a flowchart illustrating a flow of payment assistance processing according to the third example embodiment. Note that FIG. 16 is acquired by adding steps S610 and S611 between steps S607 and S608 in FIG. 11 described above. After step S607, the decision unit 345 determines whether a selected user is a person under age (S610). For example, the decision unit 345 determines whether the selected user is a person under age, based on a date of birth or an age included in the personal information 3133 in determined reservation information 313. When it is determined that the selected user is a person under age, the decision unit 345 adds display information indicating a person under age (S611). Thus, in step S609, a display control unit 346 displays, for the user determined to be a person under age, display information decided in step S607 and the display information added in step S611 in a position of the user.

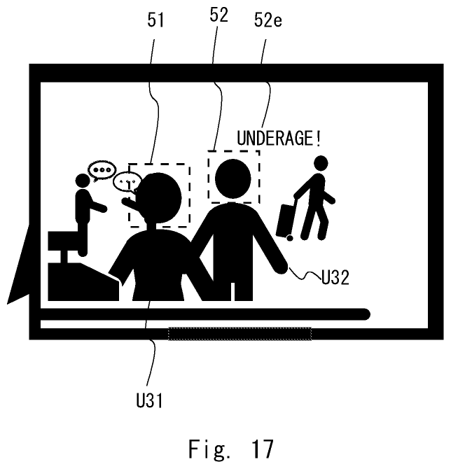

FIG. 17 is a diagram illustrating a display example of display information according to the third example embodiment. Herein, it is illustrated that display information 52e (“underage!”) is displayed in addition to the display information 52 described above near a face of an intended payment person U32 in a captured image being displayed on a screen of a display device 440. The display information 52a is one example of display information indicating a person under age. Thus, instead of the display information 52e, a frame line of the display information 52 may have a color different from a color of a frame line of an adult. A salesclerk U4 can recognize that the intended payment person U32 is a person under age and cannot purchase alcoholic beverages by visually recognizing the display information 52e being displayed on the display device 440. Thus, the salesclerk U4 can smoothly suppress sale of alcoholic beverages without requesting age confirmation from the intended payment person U32. Similarly, the salesclerk U4 can recognize that a payment target person U31 is an adult and can purchase alcoholic beverages. Thus, the salesclerk U4 can legally sell alcoholic beverages without requesting age confirmation from the payment target person U31.

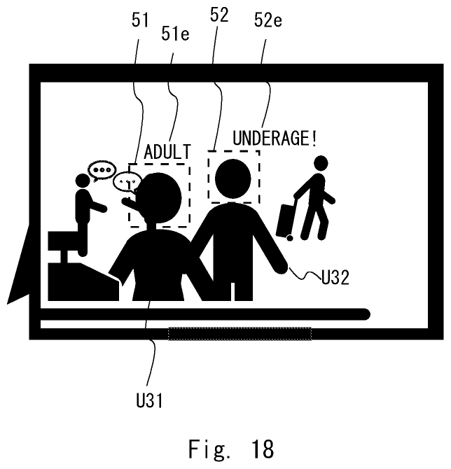

Note that the display device 440 may display both of a target person and a non-target person of service application, based on age information, in an identifiable manner. In that case, when NO is determined in step S610 in FIG. 16, the decision unit 345 adds display information indicating an adult. Subsequently, the processing may proceed to step S608 similarly to the description above. For example, it is assumed that the payment target person U31 is a member and an adult, and the intended payment person U32 is a member and a person under age. A display example in this case is illustrated in FIG. 18. Herein, it is illustrated that the display device 440 displays a frame line (display information 51) by a broken line around a face area, and characters (display information 51e) of “adult” near a face of the payment target person U31 in a captured image on the screen. Further, it is illustrated that the display device 440 displays a frame line (display information 52) by a solid line around a face area, and characters (display information 52e) of “underage!” near a face of the intended payment person U32 in the captured image on the screen. Note that, in FIG. 18, any one of the pieces of display information 51 and 51e may be displayed. Similarly, any one of the pieces of display information 52 and 52e may be displayed. Furthermore, the pieces of display information 51 and 52 being the frame lines may have different colors. Further, the pieces of display information 51 and 52 being the frame lines may be common to either the solid line or the broken line and may distinguish an adult and a non-adult by color. Alternatively, the pieces of display information 51 and 52 being the frame lines may distinguish an adult and a non-adult by the solid line or the broken line. From these, the salesclerk U4 can easily recognize that the payment target person U31 is an adult and can purchase alcoholic beverages, and the intended payment person U32 is a person under age and cannot purchase alcoholic beverages. Thus, the salesclerk U4 can legally sell alcoholic beverages without requesting age confirmation from the payment target person U31.

Note that the decision unit 345 may decide display information according to age information included in qualification information. For example, when the age information indicates a predetermined age or older, display information indicating that a senior discount can be applied may be decided.

Note that a timing at which the above-described display information indicating a person under age is displayed on the display device 440 is not limited to that described above. For example, at a timing at which the salesclerk U4 reads a product with an age limit of a purchase such as alcoholic beverages by a bar code reader and the like, the display control unit 346 may surround a face area of the payment target person U31 in the display device 440 with a red frame or display description of “underage!”. In this case, for example, at the timing at which a bar code of a product such as alcoholic beverages is read, a payment terminal 430 may notify the payment assistance apparatus 300 of the reading via a network N.

### Fourth Example Embodiment

A fourth example embodiment is a modification example of the second or third example embodiment described above. In the fourth example embodiment, a biometric authentication function is built in a payment assistance apparatus. A payment assistance system according to the fourth example embodiment is similar to the payment assistance system 1000 described above in which an authentication apparatus 200 is built in a payment assistance apparatus 300a, and thus illustration and description will be omitted.

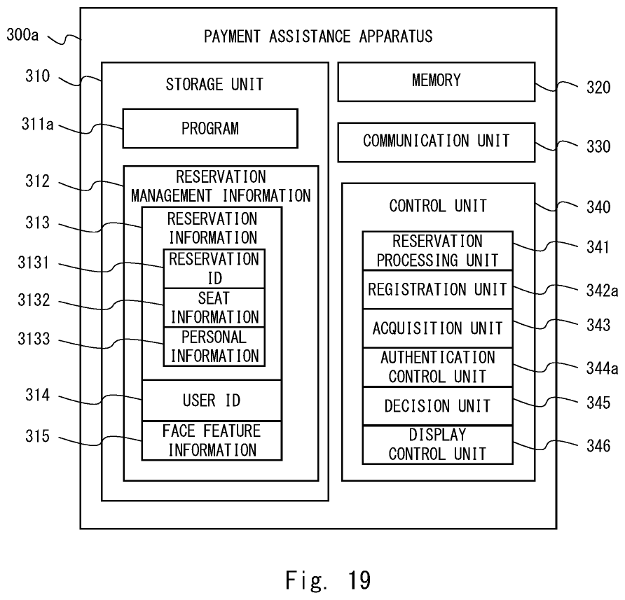

FIG. 19 is a block diagram illustrating a configuration of the payment assistance apparatus 300a according to the fourth example embodiment. In a storage unit 310 of the payment assistance apparatus 300a in comparison with the payment assistance apparatus 300 described above, the program 311 is replaced with a program 311a, and face feature information 315 is associated with a user ID 314. Further, in a control unit 340 of the payment assistance apparatus 300a in comparison with the payment assistance apparatus 300 described above, the registration unit 342 and the authentication control unit 344 are replaced with a registration unit 342a and an authentication control unit 344a.

The program 311a is a computer program in which processing of a payment assistance method according to the fourth example embodiment is implemented.

The face feature information 315 is associated with the face feature information 212 of the authentication apparatus 200 described above. The face feature information 315 is associated with the user ID 314 (identification information about a user). In other words, the storage unit 310 includes the face information DB 210 described above.

The registration unit 342a eliminates communication with the authentication apparatus 200 in the function of the registration unit 342 described above, and includes functions of a face detection unit 220, a feature point extraction unit 230, and a registration unit 240 of the authentication apparatus 200 instead.

The authentication control unit 344a compares face feature information about a plurality of persons and face feature information about a selected user, and controls face authentication. In other words, the authentication control unit 344a acquires a face authentication result by comparing face feature information extracted from a face area of a selected user and the face feature information 315 stored in the storage unit 310, and performing face authentication.

Note that, in the present example embodiment, the processing in steps S509 and S512 in FIG. 10 described above is omitted, and steps S510 and S511 are performed in the registration unit 342a. Further, in the present example embodiment, step S604 in FIG. 11 described above is replaced with face authentication processing in the payment assistance apparatus 300a by the authentication control unit 344a.

In this way, the fourth example embodiment can also acquire an effect similar to that in the second example embodiment described above. Thus, an effect similar to that in the third example embodiment can be acquired by also performing a similar improvement on the payment assistance apparatus according to the third example embodiment.

### Other Example Embodiment

Note that the example embodiments described above have been described above as a configuration of hardware, which is not limited thereto. The present disclosure can also achieve any processing by causing a CPU to execute a computer program.

In the example described above, the program may be stored by using various types of non-transitory computer-readable mediums, and may be supplied to a computer. The non-transitory computer-readable medium includes various types of tangible storage mediums. Examples of the non-transitory computer-readable medium include a magnetic recording medium (for example, a flexible disc, a magnetic tape, and a hard disc drive), a magneto-optical recording medium (for example, a magneto-optical disc), a CD-read only memory (CD-ROM), a CD-R, a CD-R/W, a digital versatile disc (DVD), and a semiconductor memory (for example, a mask ROM, a programmable ROM (PROM), an erasable PROM (EPROM), a flash ROM, and a random access memory (RAM)). Further, the program may be supplied to the computer by various types of transitory computer-readable mediums. Examples of the transitory computer-readable medium include an electrical signal, an optical signal, and an electromagnetic wave. The transitory computer-readable medium may supply the program to the computer via a wired communication path such as an electric wire and an optical fiber or a wireless communication path.

Note that the present disclosure is not limited to the example embodiments described above, and may be appropriately modified without departing from the scope of the present disclosure. Further, the present disclosure may be implemented by appropriately combining the example embodiments.

A part or the whole of the above-described example embodiments may also be described as in supplementary notes below, which is not limited thereto.

### (Supplementary Note 1)

A payment assistance apparatus including:
an authentication control means for controlling biometric authentication, based on a captured image of a predetermined user being captured at a payment place;
a decision means for deciding display information, based on qualification information about service application associated with biometric information about the user, when the biometric authentication succeeds; and
a display control means for displaying the decided display information in a position associated with the user in the captured image being displayed on a display device installed at the payment place.

### (Supplementary Note 2)

The payment assistance apparatus according to Supplementary Note 1, wherein, when the qualification information satisfies a predetermined condition, the decision means decides, as the display information, information indicating that the user is a target person of the service application.

### (Supplementary Note 3)

The payment assistance apparatus according to Supplementary Note 2, wherein the decision means determines whether the predetermined condition is satisfied in consideration of an event content held in a facility including the payment place in addition to the qualification information, and decides the display information when the qualification information and the event content satisfy the predetermined condition.

### (Supplementary Note 4)

The payment assistance apparatus according to any one of Supplementary Notes 1 to 3, wherein
the qualification information includes seat information about a predetermined viewing facility, and
the decision means determines that the predetermined condition is satisfied when seat information included in the qualification information is included in a specific seat group.

### (Supplementary Note 5)

The payment assistance apparatus according to any one of Supplementary Notes 1 to 4, wherein the service application includes discount application of a payment amount.

### (Supplementary Note 6)

The payment assistance apparatus according to any one of Supplementary Notes 1 to 5, wherein
the qualification information includes age information about the user, and
the decision means decides, as the display information, information indicating that purchase of a specific product group is not permitted when age information included in the qualification information indicates a person under age.

### (Supplementary Note 7)

The payment assistance apparatus according to any one of Supplementary Notes 1 to 6, wherein the decision means further decides the display information, based on a frequency with which the user visits a predetermined facility.

### (Supplementary Note 8)

The payment assistance apparatus according to any one of Supplementary Notes 1 to 7, wherein the decision means further decides the display information, based on preference information about the user.

### (Supplementary Note 9)

The payment assistance apparatus according to any one of Supplementary Notes 1 to 8, wherein
the qualification information includes a service type being applicable to the user, and
the decision means decides the display information being associated with a service type included in the qualification information.

### (Supplementary Note 10)

The payment assistance apparatus according to any one of Supplementary Notes 1 to 9, wherein the display control means displays the display information in such a way as to surround a face of the user in the captured image.

### (Supplementary Note 11)

The payment assistance apparatus according to any one of Supplementary Notes 1 to 10, wherein the user includes an intended payment person lining up in order to perform payment behind a current payment target person at the payment place.

### (Supplementary Note 12)

The payment assistance apparatus according to any one of Supplementary Notes 1 to 11, further including a registration means for receiving the qualification information issued for the user and biometric information acquired from the user, and registering the received qualification information and the received biometric information in association with each other,
wherein the decision means determines the qualification information being associated with biometric information about a user who succeeds in the biometric authentication, and decides the display information, based on the determined qualification information.

### (Supplementary Note 13)

The payment assistance apparatus according to Supplementary Note 12, wherein, when the registration means receives the qualification information issued for the user from a predetermined registration terminal, the registration means transmits a registration request for biometric information to the registration terminal, and receives biometric information acquired from the user in the registration terminal in response to the registration request.

### (Supplementary Note 14)

A payment assistance system including:
a display device installed at a payment place;
an image-capturing device configured to capture a user at the payment place;
an authentication apparatus in which biometric information about a predetermined user is registered; and
a payment assistance apparatus,
wherein the payment assistance apparatus includes
   an authentication control means for controlling biometric authentication using the authentication apparatus, based on a captured image of the user being captured by the image-capturing device,
   a decision means for deciding display information, based on qualification information about service application associated with biometric information about the user, when the biometric authentication succeeds, and
   a display control means for displaying the decided display information in a position associated with the user in the captured image being displayed on the display device.

### (Supplementary Note 15)

The payment assistance system according to Supplementary Note 14, wherein, when the qualification information satisfies a predetermined condition, the decision means decides, as the display information, information indicating that the user is a target person of the service application.

### (Supplementary Note 16)

A payment assistance method including,
by a computer:
controlling biometric authentication, based on a captured image of a predetermined user being captured at a payment place;
deciding display information, based on qualification information about service application associated with biometric information about the user, when the biometric authentication succeeds; and
displaying the decided display information in a position associated with the user in the captured image being displayed on a display device installed at the payment place.

### (Supplementary Note 17)

A non-transitory computer-readable medium storing a payment assistance program causing a computer to execute:
authentication control processing of controlling biometric authentication, based on a captured image of a predetermined user being captured at a payment place;
decision processing of deciding display information, based on qualification information about service application associated with biometric information about the user, when the biometric authentication succeeds; and
display control processing of displaying the decided display information in a position associated with the user in the captured image being displayed on a display device installed at the payment place.

The invention of the present application is described above with reference to the example embodiments (examples), but the invention of the present application is not limited to the example embodiments (examples) described above. Various modifications that can be understood by those skilled in the art can be made to the configuration and the details of the invention of the present application within the scope of the invention of the present application.

### REFERENCE SIGNS LIST

1 PAYMENT ASSISTANCE APPARATUS
11 AUTHENTICATION CONTROL UNIT
12 DECISION UNIT
13 DISPLAY CONTROL UNIT
1000 PAYMENT ASSISTANCE SYSTEM
110 USER TERMINAL
120 RESERVATION CODE
200 AUTHENTICATION APPARATUS
210 FACE INFORMATION DB
211 USER ID
212 FACE FEATURE INFORMATION
220 FACE DETECTION UNIT
230 FEATURE POINT EXTRACTION UNIT
240 REGISTRATION UNIT
250 AUTHENTICATION UNIT
300 PAYMENT ASSISTANCE APPARATUS
300a PAYMENT ASSISTANCE APPARATUS
310 STORAGE UNIT
311 PROGRAM
311a PROGRAM
312 RESERVATION MANAGEMENT INFORMATION
313 RESERVATION INFORMATION
3131 RESERVATION ID
3132 SEAT INFORMATION
3133 PERSONAL INFORMATION
314 USER ID
315 FACE FEATURE INFORMATION
320 MEMORY
330 COMMUNICATION UNIT
340 CONTROL UNIT
341 RESERVATION PROCESSING UNIT
342 REGISTRATION UNIT
342a REGISTRATION UNIT
343 ACQUISITION UNIT
344 AUTHENTICATION CONTROL UNIT
344a AUTHENTICATION CONTROL UNIT
345 DECISION UNIT
346 DISPLAY CONTROL UNIT
400 STADIUM
401 VIEWING REGION
4011 VIEWING SEAT
401n VIEWING SEAT
410 REGISTRATION TERMINAL
402 STORE REGION
420 CAMERA
430 PAYMENT TERMINAL
440 DISPLAY DEVICE
510 CAMERA
520 STORAGE UNIT
530 COMMUNICATION UNIT
540 INPUT/OUTPUT UNIT
550 CONTROL UNIT
551 CODE READING UNIT
552 DISPLAY CONTROL UNIT
553 IMAGE ACQUISITION UNIT
554 REGISTRATION UNIT
N NETWORK
U1 USER
U2 USER
U31 PAYMENT TARGET PERSON
U32 INTENDED PAYMENT PERSON
U33 INTENDED PAYMENT PERSON
U4 SALESCLERK
51 DISPLAY INFORMATION
51a DISPLAY INFORMATION
51b DISPLAY INFORMATION
51c DISPLAY INFORMATION
51d DISPLAY INFORMATION
51e DISPLAY INFORMATION
52 DISPLAY INFORMATION
52a DISPLAY INFORMATION
52b DISPLAY INFORMATION
52c DISPLAY INFORMATION
52d DISPLAY INFORMATION
52e DISPLAY INFORMATION

What is claimed is:

1. A payment assistance apparatus comprising:
at least one storage device configured to store instructions; and
at least one processor configured to execute the instructions to:
control biometric authentication, based on a captured image of a predetermined user being captured at a payment place;
decide display information, based on qualification information about service application associated with biometric information about the user, when the biometric authentication succeeds; and
display the decided display information in a position associated with the user in the captured image being displayed on a display device installed at the payment place.

2. The payment assistance apparatus according to claim 1, wherein the at least one processor is further configured to execute the instructions to:
when the qualification information satisfies a predetermined condition, decide, as the display information, information indicating that the user is a target person of the service application.

3. The payment assistance apparatus according to claim 2, wherein the at least one processor is further configured to execute the instructions to:
determine whether the predetermined condition is satisfied in consideration of an event content held in a facility including the payment place in addition to the qualification information, and decide the display information when the qualification information and the event content satisfy the predetermined condition.

4. The payment assistance apparatus according to claim 2, wherein
the qualification information includes seat information about a predetermined viewing facility, and
wherein the at least one processor is further configured to execute the instructions to:
determine that the predetermined condition is satisfied when seat information included in the qualification information is included in a specific seat group.

5. The payment assistance apparatus according to claim 1, wherein the service application includes discount application of a payment amount.

6. The payment assistance apparatus according to claim 1, wherein
the qualification information includes age information about the user, and
wherein the at least one processor is further configured to execute the instructions to:
decide, as the display information, information indicating that purchase of a specific product group is not permitted when age information included in the qualification information indicates a person under age.

7. The payment assistance apparatus according to claim 1, wherein the at least one processor is further configured to execute the instructions to:
decide the display information, based on a frequency with which the user visits a predetermined facility.

8. The payment assistance apparatus according to claim 1, wherein the at least one processor is further configured to execute the instructions to:
decide the display information, based on preference information about the user.

9. The payment assistance apparatus according to claim 1, wherein
the qualification information includes a service type being applicable to the user, and
wherein the at least one processor is further configured to execute the instructions to:
decide the display information being associated with a service type included in the qualification information.

10. The payment assistance apparatus according to claim 1, wherein the at least one processor is further configured to execute the instructions to:
display the display information in such a way as to surround a face of the user in the captured image.

11. The payment assistance apparatus according to claim 1, wherein the user includes an intended payment person lining up in order to perform payment behind a current payment target person at the payment place.

12. The payment assistance apparatus according to claim 1,
wherein the at least one processor is further configured to execute the instructions to:
receive the qualification information issued for the user and biometric information acquired from the user, and register the received qualification information and the received biometric information in association with each other,
determine the qualification information being associated with biometric information about a user who succeeds in the biometric authentication, and decide the display information, based on the determined qualification information.

13. The payment assistance apparatus according to claim 12,
wherein the at least one processor is further configured to execute the instructions to:
when the registration means receives the qualification information issued for the user from a predetermined registration terminal, transmit a registration request for biometric information to the registration terminal, and receive biometric information acquired from the user in the registration terminal in response to the registration request.

14. A payment assistance system comprising:
a display device installed at a payment place;
an image-capturing device configured to capture a user at the payment place;
an authentication apparatus in which biometric information about a predetermined user is registered; and
a payment assistance apparatus,
wherein the payment assistance apparatus includes:
at least one storage device configured to store instructions; and
at least one processor configured to execute the instructions to:
control biometric authentication using the authentication apparatus, based on a captured image of the user being captured by the image-capturing device,
decide display information, based on qualification information about service application associated with biometric information about the user, when the biometric authentication succeeds, and
display the decided display information in a position associated with the user in the captured image being displayed on the display device.

15. The payment assistance system according to claim 14, wherein the at least one processor is further configured to execute the instructions to:
when the qualification information satisfies a predetermined condition, decide, as the display information, information indicating that the user is a target person of the service application.

16. A payment assistance method comprising,
by a computer:
controlling biometric authentication, based on a captured image of a predetermined user being captured at a payment place;
deciding display information, based on qualification information about service application associated with biometric information about the user, when the biometric authentication succeeds; and
displaying the decided display information in a position associated with the user in the captured image being displayed on a display device installed at the payment place.

17. A non-transitory computer-readable medium storing a payment assistance program causing a computer to execute:
authentication control processing of controlling biometric authentication, based on a captured image of a predetermined user being captured at a payment place;
decision processing of deciding display information, based on qualification information about service application associated with biometric information about the user, when the biometric authentication succeeds; and
display control processing of displaying the decided display information in a position associated with the user in the captured image being displayed on a display device installed at the payment place.
